(19) United States
(12) Patent Application Publication
(10) Pub. No.: US 2015/0216635 A1
(43) Pub. Date: Aug. 6, 2015

(54) BLANK AND PROCESS FOR PRODUCING A DENTAL RESTORATION BY SUBTRACTIVE MACHINING

(71) Applicant: Ludwig-Maximilians-Universität München, München (DE)

(72) Inventor: Josef Schweiger, Bergen (DE)

(21) Appl. No.: 14/425,281

(22) PCT Filed: Sep. 3, 2013
(86) PCT No.: PCT/EP2013/068190

§ 371 Date: Mar. 2, 2015

(30) Foreign Application Priority Data
Sep. 3, 2012 (DE) 10 2012 108 153.0

(51) Int. Cl. A61C 13/00; F16B 33/00; A61C 8/00

(52) U.S. Cl. CPC A61C 13/0022; A61C 8/0074; A61C 13/0006; F16B 33/004

(57) ABSTRACT

A blank is provided for producing a dental prosthesis (tooth crown) comprising a mechanically processable material block and a holder connected thereto for clamping in an automatic processing tool. Said block is provided with a subgingival anatomic implant connecting part which is protrusively arranged thereon and in which an implant fixture for fixing it to the implant head is formed. The holder is arranged on the surface of the block arrangement side and the implant fixture to a surface on the implant side, thereby making it possible to work the blank by means of a computer-controlled conventional tool. A threaded channel which is embodied in the centre of the block in a parallel direction with respect to the surface on the fixation side, the angular orientation of the mastication surface of the tooth crown with respect to the occlusion vertical and the subgingival anatomic implant connecting part make it possible to fix the prosthetic element (tooth crown) directly to the implant without an abutment and with correct orientation in the row of teeth.

### FIELD OF THE INVENTION

The present invention is in the field of dental technology. In particular it relates to a blank and a system for producing a dental restoration by subtractive machining, a method for producing a blank and a method for producing a dental restoration by subtractive machining.

### RELATED PRIOR ART

To produce dental restorations, it is known that blanks in the form of a block can be machined subtractively and the contour of a tooth to be replaced can thereby be imported to them. For anchoring the dental restoration in the jaw, an implant is introduced into the patient's jawbone. After a healing phase, the shape of the tooth to be replaced and its position with respect to the implant are determined, after which the dental restoration can be produced. After the dental restoration has been produced, it can be attached to the implant and thereby to the patient's jaw.

Examples of blanks in the form of blocks that can be machined subtractively to produce dental restorations are known from the patent applications EP 000001506745 A1, WO002005016171 A1 and U.S. Ser. No. 02/011,0065065 A1.

In general it is desirable for dental restorations to have a high strength and a natural appearance. A high strength reduces the risk of breakage and reduces micro-movements, which can have a negative effect on the long life of the dental restoration. In addition, it is desirable to be able to produce dental restorations quickly and in a cost-efficient process. For example, if the dental restoration were produced during a treatment appointment and inserted into the patient, the time required for the patient would be greatly reduced in comparison with a treatment that is performed over a period of two or more appointments.

Hard materials such as lithium disilicate have the general disadvantage for use as dental ceramics that it is very difficult to machine them subtractively. Subtractive machining of these materials is time-consuming and does not preserve the material well. Wear on the machining tools is also comparatively high.

One example of subtractive production of a dental restoration made of lithium disilicate with a high strength is described in European Patent EP 1505041 A1, wherein a blank is first produced in the form of a block made of lithium metasilicates, which has a comparatively low strength and therefore can be machined very well subtractively. After the subtractive machining, the lithium metasilicate can be converted by a thermal process into lithium disilicate, which has a high strength. A dental restoration having a high strength can be produced by subtractive machining in this way. According to the manufacturer's recommendation, lithium disilicate is processed in the translucency stages LT (low translucency) and HT (high translucency) for in the application of fully anatomical restorations. This has the disadvantage that crowns with thick walls based on implant adhesives, for example, have an unnaturally high translucency. Because of this high translucency, the color of the dental restoration does not resemble that of a natural tooth, but instead these dental restorations made of lithium disilicate may have an unnatural appearance.

### SUMMARY OF THE INVENTION

The object of the present invention is to provide a blank, a system and a method which will make it possible to finish dental restorations with a high strength and a natural appearance more rapidly than is possible in the prior art.

The blank according to the invention comprises a structural part and a block part. The block part is connected to the exterior of the structural part in a force-locking manner. In one embodiment, the block part comprises or is made of lithium metasilicate, which is highly suitable for subtractive machining because of its comparatively low strength. The desired shape of the dental restoration, for example, the shape of a lateral tooth, may be imparted to the block part of the blank by subtractive machining. Subtractive machining can be performed in a known way, for example, using computer-controlled CAD/CAM methods. Because of the force-locking connection, the cohesion between the structural part and the block part is not impaired during subtractive machining. This makes it possible for the block part to be held via the structural part during the subtractive machining, for example.

The structural part comprises zirconium dioxide (ZrO₂) and/or titanium. These materials have a very high flexural strength and a very high modulus of elasticity, which impart a very high rigidity and stability to the dental restoration. Micro-movements of the dental restoration implanted in the patient are therefore reduced, so that the dental restoration based on the blank according to the invention has a very long life and is reliable. Furthermore, damage to the restoration such as separation of veneers is prevented.

Another advantage resulting from the use of the aforementioned materials is a reduced risk of breakage of the dental restoration. This property is important with dental restorations on implants in particular, because they do not have a natural anchoring in the jawbone and therefore the patient lacks the natural reflex arc for his dental restoration. With natural teeth, this reflex prevents the patient from biting down further when he bites on a hard object, for example, a stone, which therefore protects natural teeth from damage. This natural protective mechanism does not exist for dental restorations on implants, so their strength becomes very important.

The initial strength of lithium disilicate is in the range of approximately 360-400 MPa and the flexural strength of zirconium dioxide (ZrO₂), for example, is more than 900 MPa. Based on these properties, the combination of these materials is excellent for reducing the risk of damage with dental restorations and increasing their lifetime.

To enable the dental restoration produced from the blank according to the invention to be anchored to the patient's bone, the structural part has an internal contour that corresponds essentially to an external contour of an implant base. The implant base may comprise, for example, a connecting piece, which may be connected to an implant that has healed in the patient's jawbone. Alternatively, the implant base may also be a section of an implant, which is connected in one piece to the implant anchored in the patient's jawbone. Since the internal contour of the structural part and the external contour of the implant base essentially correspond to one another, the dental restoration can be placed upon the implant base so that it fits accurately and can be connected to and is in flush contact with it.

The blank according to the invention offers the great advantage that it can be worked quite well by subtractive machining in a first process step because of the lithium metasilicate, which is contained in the block part and has a comparatively low strength. In a second process step, the lithium metasilicate can be converted into stronger lithium disilicate by a thermal process. Based on the strength of the lithium disilicate, direct subtractive machining thereof would be far less gentle on the material and would also last longer. Furthermore, the wear on the abrasive elements would be extremely high, so that the machining would be uneconomical on the whole or would even be impossible when using small grinding tools.

However, lithium disilicate has the disadvantage that it has a very high translucency, so that a dental restoration using only lithium disilicate would, to some extent, have an unnatural appearance. Because of the opaque structural part, this disadvantage is not manifested in a dental restoration made of the blank according to the invention because the dental restoration is translucent only at the surface, namely as far as the more opaque structural part and therefore has an appearance very similar to that of a natural tooth (dentin-enamel structure of a natural tooth). The color of the dental restoration can be adapted to the color of a natural tooth through the color of the structural part and also the color of the block part. The subtractive machining and the conversion of lithium metasilicate to lithium disilicate may take place relatively rapidly, so that the production of the dental restoration from the blank according to the invention and the attachment of the dental restoration to the patient can be done in a single treatment session.

Instead of being made of lithium metasilicate, the block part may also be made of a glass ceramic and/or a glass ceramic precursor. A glass ceramic is an inorganic nonmetallic material in which one or more crystalline phases are surrounded by a glass phase. The term “glass ceramic precursor” in the present disclosure is understood to refer to any material that can be converted to a glass ceramic by a heat treatment. Such a glass ceramic precursor is often porous, and the thermal treatment of the porous precursor will typically have features of a sintering process, in particular including compaction of the material. Another aspect of the heat treatment is a transition of the glass phase to a fine-grained crystalline structure. Herein, it is important that the glass ceramic precursor is not as strong and therefore can be processed more easily than the finished glass ceramic. It should also be pointed out that the “glass ceramic precursor” could in many cases itself be referred to as a glass ceramic, but with a reduced strength in comparison with the condition after the heat treatment, i.e., in the finished dental restoration.

Instead of the structural part, which can be attached to an implant base, the blank according to the invention may also comprise a structure-connecting part. The structure-connecting part comprises zirconium dioxide (ZrO₂) and has a connecting geometry. With the help of the connecting geometry, the structure-connecting part and thus the dental restoration may be attached to an implant.

The structure-connecting part corresponds to a one-piece combination of a structural part and an implant base. The structure-connecting part may therefore comprise features, which, in the present description, are described only with respect to the implant base and/or the structural part.

The aforementioned force-locking connection between the block part and the structural part is preferably stable at temperatures up to at least 800° C., especially preferably up to at least 840° C., and in particular up to at least 850° C. The aforementioned force-locking connection is preferably stable at temperatures up to at least the temperature at which at least partial conversion, preferably a complete conversion, from lithium metasilicate to lithium disilicate begins to be possible. Because of the thermal stability of the compound, the force-locking connection between the structural part and the block part is ensured even at high temperatures, so that the aforementioned compound persists even during or after the conversion of lithium metasilicate to lithium disilicate. However, thermal stability of the compound is not absolutely essential because this compound can be replaced by another compound, as described further below, without any loss of the force-locking effect.

The block part is preferably sintered to the structural part with the help of a joining material, in particular a silicate ceramic material. In addition to sintering, the joining material may also serve to adjust the color of the dental restoration, in particular if the structural part contains titanium. To do so, the joining material is selected in a suitable color, so that the resulting color of the dental restoration corresponds to the color of a natural tooth.

The joining material preferably has a transformation temperature at which the block part enters into the aforementioned bond with the structural part in sintering with the help of the joining material. The transformation temperature is preferably <850° C. and especially preferably ≦840° C. and/or preferably ≧350° C. and especially preferably ≧400° C. Because of the aforementioned temperature ranges, the structural part can be joined to the block part by a sintered bond in a force-locking manner without complete conversion of the lithium metasilicate to lithium disilicate, for example, so that the blank remains well suitable for subtractive machining.

In an alternative embodiment of the blank according to the invention, the block part is glued to the structural part with the help of a hybrid material. The hybrid material comprises an organic adhesive and a sintering material. The organic adhesive permits a force-locking connection of the structural part and the block part at comparatively low temperatures, so that the cohesion of the block part and the structural part during subtractive machining is ensured by the adhesive material. The sintering material is suitable for sintering the block part to the structural part at temperatures of <850° C. The adhesive bond can therefore be converted to a sintered bond by thermal treatment after subtractive machining.

The structural part preferably has a lateral wall thickness d₁ of ≦2.5 mm and especially preferably of ≦2 mm and/or a lateral wall thickness d₁ of ≧0.3 mm, especially preferably of ≧0.5 mm. The outside diameter of the structural part is preferably ≦7 mm and especially preferably ≦6 mm and/or preferably ≧2 mm and especially preferably ≧3 mm. It has been found that very good strength values are obtained within these ranges and that the tooth color and the surface translucency can be adjusted as desired.

Since more space is usually available for the dental restoration in the occlusal direction than in the lateral direction, the wall thickness in the occlusal direction is preferably chosen to be somewhat thicker than that in the lateral direction. The occlusal wall thickness d₀ of the structural part is preferably ≦3 mm, especially preferably ≦2.5 mm and in particular ≦2 mm and/or preferably ≧0.3 mm, especially preferably ≧0.5 mm and in particular ≧0.7 mm. The occlusal wall thickness d₀ may also vary with the position of the dental restoration: for front teeth it is preferably ≧0.3 mm and for side teeth it is preferably ≧0.5 mm.

In an advantageous embodiment of the blank according to the invention, the internal contour of the structural part is not rotationally symmetrical with the occlusal axis Aₒ of the blank. The dental restoration can therefore be attached to the implant base in only one position and is secured against twisting.

In another advantageous embodiment, the internal contour of the structural part has at least one indentation. The indentation has the advantage that in adhesive bonding of the dental restoration to the implant base, adhesive material can penetrate into the indentation. Therefore the strength of the adhesive bond is increased and the risk of separation of the dental restoration in the occlusal direction in particular is reduced.

The indentation may be designed to be partial or it may also be designed to be circular on the internal contour of the structural part.

In another advantageous embodiment, the blank according to the invention includes a channel to receive a plug screw. If the implant base is an abutment that is not connected in one piece to the implant, then the dental restoration can be screw-connected to the implant with the help of an implant screw. After the implant screw has been tightened with a tool through the channel, the channel can be sealed with the help of the plug screw. Alternatively or additionally the plug screw may also serve to fasten the dental restoration onto the implant base (abutment or part of the implant).

In addition to a blank according to one of the embodiments described above, the invention comprises a system for producing a dental restoration. The system comprises a blank according to the invention having a channel, a plug screw and an implant base. The implant base has an external contour, which corresponds essentially to the aforementioned internal contour of the structural part of the blank according to the invention, so that the blank can be applied to the implant base with an accurate fit. In addition, the implant base contains a screw channel to receive the plug screw, into which the plug screw can be screwed for closing the channel.

The plug screw preferably comprises a threaded section and a plug section. The threaded section can be screwed into the screw channel of the implant base and the plug section can close the aforementioned channel in the blank according to the invention after being screwed in.

In a further embodiment, the plug section does not have any thread and/or the sectional diameter of the plug section is greater than the sectional diameter of the threaded part.

In one alternative embodiment of the system according to the invention, the plug section has threads and/or the sectional diameter of the plug section corresponds essentially to the sectional diameter of the threaded part.

In addition, the invention relates to a method for producing a blank according to any one of the embodiments described above. This method comprises sintering of a block part on a structural part, wherein the block part comprises lithium metasilicate or a glass ceramic precursor. The sintering is performed by using a temperature profile in which lithium metasilicate is not converted or at least not converted completely to lithium disilicate and/or in which the glass ceramic precursor has not yet been converted completely to a glass ceramic, or at least has not been converted to a glass ceramic having the final strength desired for the finished dental restoration. It is therefore possible to produce a blank which, because of the lithium metasilicate and/or the glass ceramic precursor, can be worked very well by subtractive machining. After conversion of lithium metasilicate to lithium disilicate, which has a higher strength and is sintered in a force-locking manner to the structural part, which has flexural strength, or after the glass ceramic precursor has been converted to the glass ceramic for the finished dental restoration, the dental restoration has a high strength and stability. Despite the lithium disilicate or the glass ceramic, the dental restoration has a natural appearance, namely being translucent at the surface and more opaque at a depth (imitation of the enamel-dentin structure of a natural tooth), because of the opaque structural part and/or the joining material.

The sintering is preferably performed with the help of a joining material, in particular a silicate ceramic material, e.g., IPS e.max CAD Crystall./Connect (Ivoclar).

Sintering is performed at a first temperature, which is preferably ≧300° C., especially preferably ≧400° C. and/or preferably <850° C., especially preferably ≦840° C. The duration of the sintering process is preferably ≧10 min, especially preferably ≧20 min and in particular ≧30 min and/or preferably ≦120 min, especially preferably ≦90 min and in particular ≦40 min. Because of the use of these temperatures and times, the lithium metasilicate is not converted completely to lithium disilicate and the block part is nevertheless bonded to the structure in a force-locking manner.

In an alternative embodiment of the method according to the invention, the block part is bonded to the structural part with the help of a hybrid material. The hybrid material comprises an organic adhesive material and a sintering material that is suitable for sintering the block part to the structural part at a temperature of <850° C.

The method according to the invention also preferably comprises a subtractive machining of the block part, which is at least partially made of lithium metasilicate and/or a glass ceramic precursor, and heating the subtractively machined blank. The lithium metasilicate of the machined block part is at least partially converted to lithium disilicate due to this heating, or the glass ceramic precursor is converted to a glass ceramic, whose strength exceeds the strength of the glass ceramic precursor.

After bonding the block part and the structural part to the hybrid material, the method according to the invention preferably also includes a heating step. During the heating, the block part is sintered to the structural part with the help of the aforementioned sintering material of the hybrid material. This heating step can be carried out together with or separately from the aforementioned heating to at least partially convert lithium metasilicate to lithium disilicate or to at least partially convert the glass ceramic precursor to the finished glass ceramic. In doing so, the adhesive bond is replaced or supplemented by a sintered compound. When the adhesive bond is replaced or supplemented, the aforementioned force-locking effect itself is not even temporarily lost.

To convert lithium metasilicate at least partially to lithium disilicate, the heating is performed at a second temperature, which is preferably ≧800° C., especially preferably ≧820° C., and in particular ≧830° C. and/or preferably ≦950° C., especially preferably ≦900° C. and in particular ≦850° C. The duration of this heating is preferably ≧10 min, especially preferably ≧20 min and in particular ≧30 min and/or preferably ≦120 min, especially preferably ≦90 min and in particular ≦40 min. These temperatures are high enough to convert lithium metasilicate to lithium disilicate, but are not high enough to cause the lithium disilicate to become plastic, so that the shape would change and/or the subtractively machined block part would melt. If a glass ceramic is used for the block part, the temperatures may be adjusted accordingly to convert the glass ceramic precursor into a glass ceramic having the desired strength.

For subtractive machining of the block part, the blank is preferably held via the structural part. For example, the blank for subtractive machining may be connected to the machine connecting part by means of the structural part with the help of an adhesive bond and/or a screw connection using the plug screw. Alternatively, the blank may also be connected to the implant base for the subtractive processing and may be clamped in the machine by means of this implant base. Since the implant base is preferably metallic, for example, made of titanium, the connection to the implant base must be released before the lithium metasilicate is converted to lithium disilicate and/or the glass ceramic precursor is converted to the finished glass ceramic. Otherwise the implant base would undergo oxidation when heated. The subsequent removal of the oxide would result in an inaccurate fit when the implant base is attached to the implant. In the alternative use of a ceramic implant base, the heating and thus a non-releasable connection (e.g., a sintered connection) are possible.

In an advantageous embodiment of the method according to the invention, the subtractive machining of the block part also comprises subtractive machining of the plug screw. The blank according to the invention together with the plug screw, for example, is therefore screwed onto the holding device. Next the block part of the blank can be machined subtractively. In doing so, at the same time the plug part of the plug screw is machined subtractively and adapted to the contour of the dental restoration. Next, the external contour of the plug screw may also be provided with a geometric shape, for example, a slot or a cross, which makes it possible to screw the threaded section into the screw channel of the implant base using a tool.

In an advantageous embodiment of the method according to the invention, the structural part is connected to the implant base, in particular by adhesive bonding and/or screw connection with the help of the plug screw. The structural part can also be connected to the implant base, in particular to a ceramic implant base, e.g., made of ZrO₂, by sintering. Depending on whether the connection is by adhesive bonding or sintering, the implant base is an implant adhesive base or an implant sintered base, respectively.

### BRIEF DESCRIPTION OF THE FIGURES

Additional advantages and features of the invention are derived from the following description, which explains preferred exemplary embodiments in greater detail with reference to the accompanying drawings, in which:

FIG. 1 shows a first embodiment of the blank according to the invention with a plug screw,

FIG. 2 shows a second embodiment of the blank according to the invention with a plug screw,

FIG. 3 shows a third embodiment of the blank according to the invention with a plug screw, and

FIG. 4 shows an embodiment of the system according to the invention, which is screw-connected to an implant,

FIG. 5 shows a fourth embodiment of the blank according to the invention with a plug screw, and

FIG. 6 shows a fifth embodiment of the blank according to the invention with a plug screw.

### DESCRIPTION OF PREFERRED EMBODIMENTS

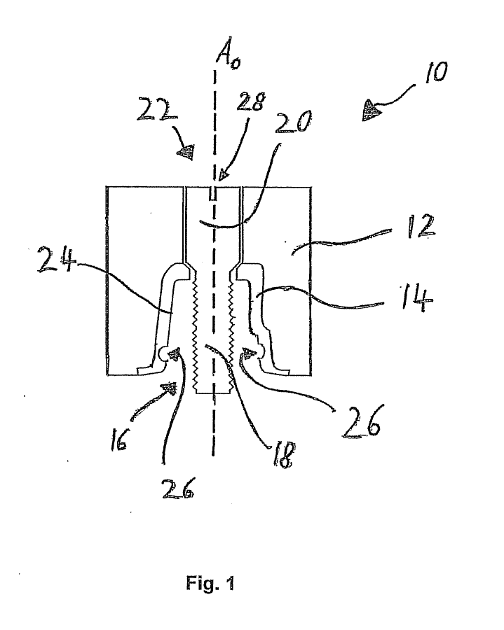

FIG. 1 shows a vertical section through a blank 10 according to the invention, comprising a block part 12 and a structural part 14. FIG. 1 also shows a plug screw 16, comprising a threaded section 18 and a plug section 20. The blank 10 contains a channel 22, which is plugged by the plug section 20 of the plug screw 16. The structural part 14 has an internal contour 24, which comprises two indentations 26. The plug screw 16 comprises a slot 28 to allow it to be screw-connected using a tool.

The block part 12 comprises lithium metasilicate and is connected in a force-locking manner to the exterior side of the structural part 14. Instead of the lithium metasilicate, the block part 12 may also comprise and/or consist of a glass ceramic precursor, which can be converted by a heat treatment into a glass ceramic having a strength suitable for use in a dental restoration. This variant is not described explicitly below, but it is to be understood that all the advantages and features described below shall also be disclosed in conjunction with this variant. The internal contour 24 of the structural part 14 corresponds essentially to an external contour of an implant base (not shown). A dental restoration produced from the blank 10 may therefore be placed on the external contour of the implant base (not shown) and attached to the patient's jaw by means of the implant base. FIG. 1 shows that the internal contour 24 of the structural part 14 is not rotationally symmetrical with the occlusal axis Aₒ of the blank 10. The dental restoration produced from the blank 10 can therefore be attached to the implant base (not shown) in only one position and cannot be twisted with respect to this position. The dental restoration produced from the blank 10 can be attached to the implant base (not shown) by means of an adhesive bond, for example, and/or by means of a screw connection with the help of the plug screw 16 over the internal contour 24 of the structural part 14. Furthermore, the dental restoration can also be sintered to the implant base. The sintered connection preferably uses a ceramic implant base to prevent oxidation. In adhesive bonding, adhesive material can penetrate into the indentations 26. This therefore increases the stability of the adhesive bond and in particular reduces the risk that the dental restoration will be shifted along the occlusal axis Aₒ relative to the implant base or released from it.

With the plug screw 16 shown in FIG. 1, the sectional diameter of the plug section 20 is larger than the sectional diameter of the threaded section 18. Since the diameter of the channel 22 is smaller at the lower end than the sectional diameter of the plug section 20 of the plug screw 16, the blank 10 and/or the dental restoration produced from it can be screw-connected to the implant base (not shown) with the help of the plug screw 16. When the plug screw 16 is tightened, the dental restoration is pulled toward the implant base in the direction of the occlusal axis Aₒ. The plug screw 16 may thus also have a fastening function in addition to the plug function in combination with the blank 10 according to the invention.

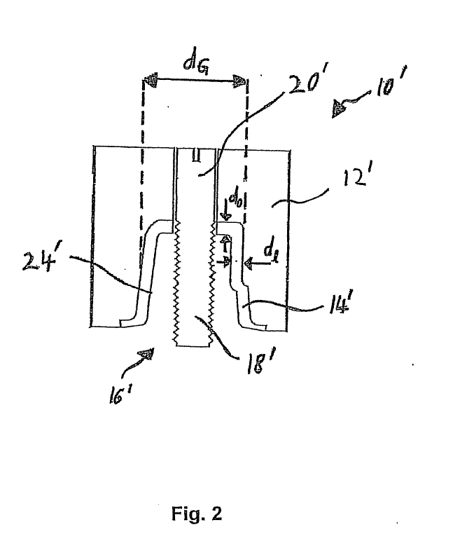

FIG. 2 shows another embodiment of the blank 10′ according to the invention, which can be used with the plug screw 16′ shown herein. In the plug screw 16′, the sectional diameter of the plug section 20′ and the sectional diameter of the threaded section 18′ are essentially the same, so that the plug screw 16′ in combination with the blank 10′ has merely a plug function. As shown in FIG. 2, the structural part 14′ has an outside diameter d_{G}, an occlusal wall thickness dₒ and a lateral wall thickness d₁. The embodiment of the blank 10′ shown in FIG. 2 has no indentations on the internal contour 24′ of the structural part 14′.

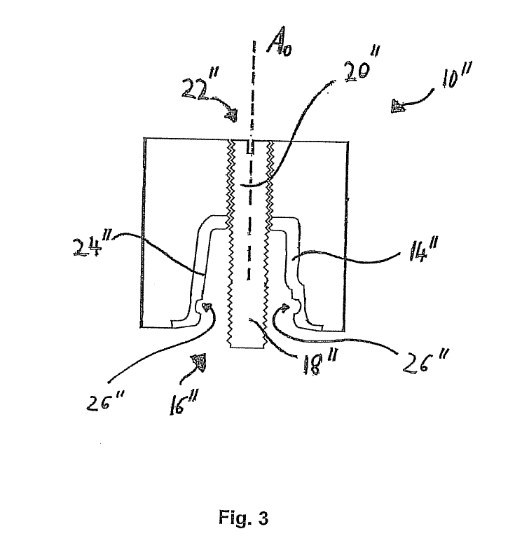

FIG. 3 shows another embodiment of the blank 10″ according to the invention, in which the channel 22″ has threads (in contrast with the blanks 10 and 10′ from FIG. 1 and FIG. 2). The dental restoration produced from the blank 10″ can be used with a plug screw 16″ with which the sectional diameter of the threaded section 18″ and the sectional diameter of the plug section 20″ are essentially the same, and in which both the threaded section 18″ and the plug section 20″ have threads. The indentations 26″ on the internal contour 24″ of the structural part 14″ and the threads on the plug section 20″ prevent the dental restoration, which is screwed and/or glued onto an implant base (not shown), from being removable from the implant base in the channel 22″ by pulling in the direction of the occlusal axis Aₒ.

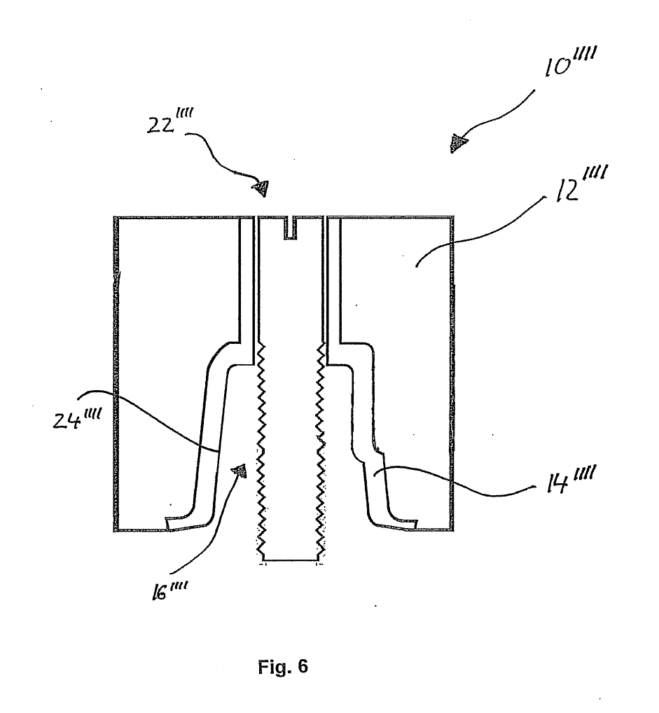

As shown in FIG. 6, the structural part 14″″ may also extend completely through the block part 12″″—instead of extending only partially up to the channel 22″″. In FIG. 6, the channel 22″″ is bordered in the lateral direction by the structural part 14″″—and not by the block part 12″″. The internal contour 24″″, which corresponds essentially to the external contour of an implant base (not shown), does not comprise the contour of the structural part 14″″, which defines the channel 22″″.

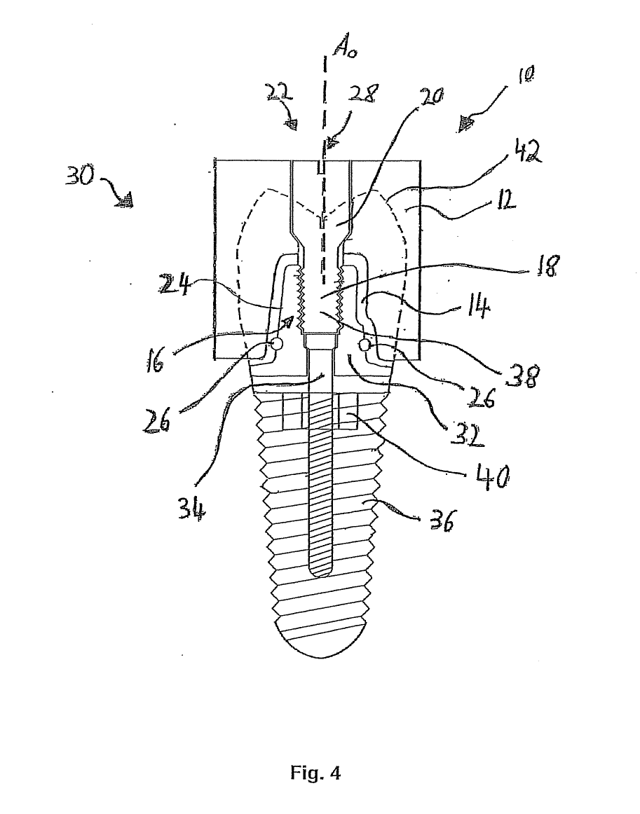

FIG. 4 shows a system 30 according to the invention, comprising a blank 10, a plug screw 16 and an implant base 32. The system 30 is screw-connected to an implant 36 with the help of an implant screw 34. The implant base 32 comprises a screw channel 38 and a connecting geometry 40. The connecting geometry 40 of the implant base 32 can be inserted into the implant 36 with an accurate fit and preferably has an anti-rotational geometry such as a hexagon, an octagon, etc., so that the system 30 cannot be rotated against the implant 36 in a screw connection to the implant 36.

It is described below on the basis of FIG. 4 as an example how, with the help of the present invention, a missing tooth can be replaced by a dental restoration having the tooth contour 42 in a patient.

First, instead of the missing tooth, the implant 36 is implanted in the patient's jawbone. After a healing phase which is necessary in order for the implant 36 to be able to heal in place in the patient's jawbone, the treatment is continued. With the help of the present invention, during a single treatment session, the dental restoration can be produced from the blank 10 according to the invention and can be attached to the implant 36 after the implant 36 has healed in place.

In this treatment session, the tooth contour 42 of the dental restoration to be produced is first determined by a known method (for example, scanning, CAD construction). Next the tooth contour 42 is transferred to the block part 12 of the blank 10 by subtractive machining, for example, with the help of a computer-controlled CAD/CAM method. To do so, the blank 10 may be accommodated in the machine by means of a machine connecting part (not shown). The machine connecting part has a section (not shown) with an external contour (not shown), which corresponds essentially to the internal contour 24 of the structural part 14. For subtractive machining, the blank 10 may be screw-connected to the machine connecting part with the help of the plug screw 16, for example. Another possibility consists of releasable adhesive bonding of the structural part 14 of the blank 10 to the machine connecting part. In both cases, it is of great practical importance that the structural part 14 of the blank is already connected to the block part 12 in a force-locking manner, even before the subtractive machining. The machine connecting part preferably comprises a screw channel (not shown), into which the plug screw 16 can be screwed. In the screwed-in state, the channel 22 of the blank 10 is plugged or closed by the plug section 20 of the plug screw 16.

After being chucked in the machine tool, the block part 12 is machined subtractively, wherein the plug section 20 of the plug screw 16 is preferably also machined subtractively, so that the desired tooth contour 42 is also created in the position of the channel 22. After subtractive machining of the plug section 20, a geometry is preferably created in the plug section 20, for example, a slot, a cross slot, a hexagon socket head (Allen wrench head), Torx, etc. Therefore, the plug screw 16 can also be unscrewed from the screw channel by means of a tool and/or subsequently screwed into the screw channel 38 in the implant base 32.

Since the block part 12 of the blank 10 comprises lithium metasilicate, subtractive machining can be performed in a very time-efficient manner that saves on material. The wear on the machining tools is much lower than with harder materials, so that cost savings are possible. The waiting time for the patient is shortened because of the rapid subtractive machining, and this facilitates the treatment in one appointment.

The force-locking connection between the block part 12 and the structural part 14 makes it possible to accommodate the blank 10 for subtractive machining by means of the structural part 14 in the machining tool. This has the advantage that the block part 12 can be machined completely and there are no regions for example, because of fastening in the machine tool that are excluded from the subtractive machining and have to be remachined later. The dentist and/or dental technician also typically could not produce the force-locking connection himself in his practice because this would include, for example, presintering, which must be carried out by skilled workers using special equipment. If the structural part were not connected to the block part 12 in a force-locking manner even before the subtractive machining, this connection would have to be performed at another location after the machining of the block part 12, so the dental restoration could not be produced and inserted within one treatment session. The cost and effort of such a sintered joint after subtractive machining are very high, and they require technical dental knowledge and skills and are therefore unsuitable for “chairside use” (=use in a dental practice).

After subtractive machining, the machined blank 10 is exposed to the process conditions already described in order to at least partially convert the lithium metasilicate of the machine block part 12 into lithium disilicate. The aforementioned machine connecting part can be released from the structural part 14 before or after this conversion step.

The blank 10 may optionally be cast in plastic (e.g., polyurethane) for subtractive machining, in which case, after the subtractive machining, the restoration is held by retaining webs on the remainder of the blank 10 that has been machined out and is thus held in the plastic embedding.

Alternatively, the blank 10 for the subtractive machining can also be held in the machining tool via the implant base 32. Since the implant base 32 preferably comprises a metal, it must be released from the structural part 14 of the machined blank 10 before the of transformation process, because the metal of the implant base 32 would otherwise already be oxidized during the transformation process. The removal of the oxide would lead to an inaccurate fit in a subsequent connection to the implant 36, which would be undesirable. However, the implant base 32 need not necessarily be metallic but instead may also be ceramic. In this case, the implant base 32 can be exposed to the process conditions of the transformation process without oxidizing. The connection between the implant base 32 and the structural part 14 after the transformation thus can remain in existence.

After the transformation, the dental restoration based on the lithium disilicate and the structural part both have a high stability and strength. The grayish appearance of lithium disilicate typically occurring when the wall thickness is large, which is due to a comparatively high translucency can be corrected by the opaque structural part 14 and/or the joining material, by means of which the block part 12 is connected to the structural part 14. The dental restoration is therefore translucent only at the surface and therefore resembles the appearance of a natural tooth. If the structural part 14 includes zirconium dioxide, then the desired tooth color can be adjusted very well by adjusting the color of the structural part 14. The glaze and stain firing can be performed separately or in combination with the crystallization firing (conversion of lithium metasilicate to lithium disilicate).

After the transformation, the dental restoration may be attached to the implant that has healed in place. To do so, on the one hand, the implant base 32 is screw-connected to the implant 36 with the help of the implant screw 34 and, on the other hand, the structural part 14 is attached to the implant base 32.

The structural part 14 and the implant base 32 can be joined with the help of the plug screw 16 for example, after the screw connection of the implant base 32 with the help of the implant screw 34. Alternatively or additionally, the implant base and the structural part 14 may be adhesively bonded or sintered. If the implant base 32 consists of an abutment, the adhesive bonding is preferably performed before the screw connection with the help of the implant screw 34 because it can then be performed outside of the patient's oral cavity. To improve the stability of the adhesive bond, the internal contour 24 of the structural part 14 and/or the external contour of the implant base 32 may have indentations 26. These indentations 26 may be designed to be partially or completely circular. The indentation profile may be designed in various geometric shapes, for example, as a semicircle, a semioval, a rectangle, etc.

After the machined blank 10 that has been converted to lithium disilicate has been joined to the implant base 32 and the implant base 32 has been screw-connected to the implant 36 with the help of the implant screw 34, the plug screw 16 can be screwed into the screw channel 38 of the implant base 32. In the screwed-in state the subtractively machined plug part 20 of the plug screw 16 closes the channel 22. The external contour of the machined plug section 20 corresponds to the respective section of the desired tooth contour 42. It is not necessary to fill the channel 22 with a filling material to close it.

It is pointed out that the implant base need not necessarily represent a part that is separate from the implant—as described with reference to FIG. 4. Alternatively, the implant base may also be designed in one piece with the implant, in particular forming an implant section.

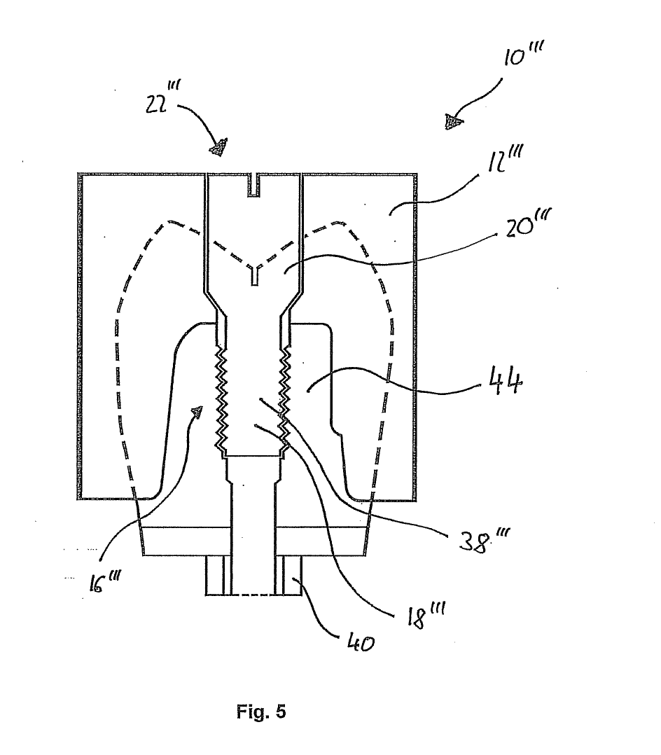

The embodiment of the blank 10′″ shown in FIG. 5 comprises a structure-connecting part 44, which combines the functions of the implant base and the structural part. As described in the preceding description for the structural part, the structure-connecting part 44 may also be connected to the block part 12′″ of the blank 10′″ from FIG. 5. The structure-connecting part comprises a connecting geometry 40 with which a dental restoration produced from the blank 10′″ can be connected to an implant 36 (FIG. 4).

Although preferred exemplary embodiments are shown and described in detail in the drawings and in the preceding description, these should be regarded merely as examples of the invention and not restrictively. It should be pointed out that only the preferred exemplary embodiments are depicted and described and all the changes and modifications that currently and in the future will lie within the scope of protection of the invention should be protected. The features shown here may be important in any combinations.

### LIST OF REFERENCE NUMERALS

10, 10′, 10″, 10′″, 10″″ blank
12, 12′, 12′″, 12″″ block part
14, 14′, 14″, 14″″ structural part
16, 16′, 16″, 16′″, 16″″ plug screw
18, 18′, 18″ threaded section
20, 20′, 20″, 20′″, 20″″ plug section
22, 22″ channel
24, 24′, 24″, 24″″ internal contour
26, 26″ indentations
28 slot
30 system
32 implant base
34 implant screw
36 implant
38 screw channel
40 connecting geometry
42 tooth contour
44 structure-connecting part

1. A blank for producing a dental restoration by subtractive machining, wherein the dental restoration is suitable for being connected to an implant base and wherein the blank comprises the following:
a structural part, which comprises zirconium dioxide (ZrO₂) or titanium, wherein the structural part has an internal contour, which corresponds essentially to an external contour of the implant base, and
a block part, which comprises lithium metasilicate, a glass ceramic or a glass ceramic precursor,
wherein the block part is connected to the outside of the structural part in a force-locking manner.

2. The blank according to claim 1, wherein the lateral wall thickness d_{I} of the structural part is ≦2.5 mm and ≧0.3 mm and the outside diameter d_{G} of the structural part is ≦7 mm and ≧2 mm.

3. The blank according to claim 1, wherein the occlusal wall thickness dₒ of the structural part is ≦3.0 mm, and ≧0.3 mm.

4. The blank according to claim 1, wherein the internal contour of the structural part is not rotationally symmetrical with the occlusal axis (Aₒ) of the blank.

5. The blank according to claim 1, wherein the internal contour of the structural part comprises at least one indentation.

6. (canceled)

7. The blank according to claim 1, wherein the aforementioned connection between the block part and the structural part has thermal stability up to at least 800° C.

8. The blank according to claim 1, wherein the block part and the structural part are sintered with the help of a joining material.

9. The blank according to claim 8, wherein a transformation temperature of the joining material, at which the block part enters into the aforementioned connection to the structural part by sintering with the help of the joining material is <850° C. and ≧350° C.

10. The blank according to claim 1, wherein the block part is adhesively bonded to the structural part with the help of a hybrid material, wherein the hybrid material comprises an organic adhesive material and a sintering material, wherein the sintering material is suitable for sintering the block part to the structural part at a temperature of <850° C.

11. The blank according to claim 1, further having a channel to receive a plug screw.

12. The blank of claim 10, further comprising
a plug screw for sealing the aforementioned channel, and
an implant base for connecting the dental restoration to an implant, wherein the implant base has an exterior contour which corresponds essentially to the aforementioned interior contour of the structural part and wherein the implant base further has a screw channel for receiving the plug screw.

13. The blank according to claim 12, wherein the plug screw comprises the following:
a threaded section, which is suitable for being screwed into the screw channel of the implant base, and
a plug section, which is suitable for sealing the aforementioned channel in the screwed-in state.

14. The blank according to claim 13, wherein the plug section does not have any threads and the sectional diameter of the plug section is larger than the sectional diameter of the threaded part.

15. The blank according to claim 13, wherein the plug section has threads and the sectional diameter of the plug section corresponds essentially to the sectional diameter of the threaded part.

16. The blank according to claim 29, said blank further comprising
a channel and a plug screw for sealing the aforementioned channel,
wherein the structure-connecting part further has a screw channel for receiving the plug screw.

17. The blank according to claim 16, wherein the plug screw comprises the following:
a threaded section, which is suitable for being screwed into the screw channel of the structure-connecting part, and
a plug section, which is suitable for sealing the aforementioned channel in the screwed-in state.

18. (canceled)

19. (canceled)

20. A method for producing a blank for producing a dental restoration, which blank comprises a structural part or a structure-connecting part comprising zirconium dioxide (ZrO₂), and a block part comprising lithium metasilicate or a glass ceramic precursor, wherein the method comprises:
sintering said block part, onto said structural part or onto said structure-connecting part, wherein the sintering is carried out using a first temperature profile, at which
lithium metasilicate is not converted or at least not converted completely to lithium disilicate or
the glass ceramic precursor is not yet converted to a glass ceramic having the final strength as desired in the finished dental restoration.

21. The method according to claim 20, wherein the sintering is carried out using a joining material.

22. The method according to claim 20, wherein the sintering is carried out at a first temperature which is ≧300° C. and <850° C.

23. A method for producing a blank for producing a dental restoration which blank comprises a structural part or a structure-connecting part comprising zirconium dioxide (ZrO₂), and a block part comprising lithium metasilicate or a glass ceramic precursor, wherein the method comprises the following step:
adhesive bonding of the block part to the structural part or to the structure-connecting part with the help of a hybrid material, wherein the hybrid material comprises an organic adhesive material and a sintering material, wherein the sintering material is suitable for sintering the block part to said structural part or to said structure-connecting part at a temperature of ≦840° C.

24. The method according to claim 20, which additionally comprises:
subtractive machining of the block part,
heating the subtractively machined blank, wherein the lithium metasilicate of the machined block part is converted at least partially to lithium disilicate, or the glass ceramic precursor is converted to a glass ceramic, whose strength exceeds the strength of the glass ceramic precursor.

25. (canceled)

26. (canceled)

27. The method according to claim 24, wherein
the blank is held by means of the structural part or by means of the structure-connecting part during the subtractive machining of the block part.

28. (canceled)

29. A blank for producing a dental restoration by subtractive machining, wherein the dental restoration is suitable for being connected to an implant and wherein the blank comprises:
a structure-connecting part which comprises zirconium dioxide (ZrO₂), wherein the structure-connecting part has a connecting geometry by means of which the dental restoration can be connected to the implant, and
a block part which comprises lithium metasilicate,
wherein the block part is connected to an outside section of the structure-connecting part in a force-locking manner.
